(19) United States
(12) Patent Application Publication
(10) Pub. No.: US 2009/0124939 A1
(43) Pub. Date: May 14, 2009

(54) EQUIPMENT FOR THE SELECTIVE STIMULATION OF CERTAIN PARTS OF THE BODY

(75) Inventors: Ulrich Hansenberger, Oberuzwil (CH); Viktor Wick, Niederburen (CH); Felix Lenz, Niederburen (CH)

Correspondence Address: MCDONALD HOPKINS LLC, 600 Superior Avenue, East, Suite 2100, CLEVELAND, OH, 44114-2653, US

(73) Assignee: VISION INDUSTRIAL SERVICES GMBH, Appenzell (CH)

(21) Appl. No.: 11/663,254

(22) PCT Filed: Sep. 13, 2005
(86) PCT No.: PCT/EP2005/054536

§ 371 Date: Dec. 23, 2008

(30) Foreign Application Priority Data
Sep. 17, 2004 (EP) 04022121.0

(51) Int. Cl. A61H 1/00

(52) U.S. Cl. 601/46

(57) ABSTRACT

The invention relates to equipment for biomechanical stimulation, comprising a base unit, a support unit (4) that is mounted on the base unit in such a way that the position of the support unit can be continuously adjusted in relation to the base unit and a cylindrical stimulation unit (9). The latter contains a drive motor (10) and is connected to the support unit in such a way that during operation it executes a circular or elliptical movement about an axis that differs from the cylinder axis and undergoes a parallel displacement. The equipment can used, in particular, for the selective therapeutic treatment of certain parts of the body, preferably the leg or back muscles.

The present invention relates to an improved device for the selective biomechanical stimulation of certain parts of the body.

Biomechanical muscle stimulation (BMS) was developed by Prof. Nazarov in Russia at the end of the 1970s and was primarily used there in the field of competitive sport. BMS is based on exclusively mechanical influence on the human body using vibrations at a respective particular frequency and with a particular amplitude, which are selected according to the desired application. The vibrations which resemble and imitate the natural vibrations of the body act on tensed or stretched muscles along the muscle fiber. By deliberately influencing the body's own vibration parameters, BMS thus gives rise to positive effects on the circulatory and lymph system, for example.

Considerably increased circulation in the muscle or in the relevant part of the body thus results on account of an increase in the muscle movements, which increase is caused by BMS. This can be used to treat illnesses such as peripheral circulatory disorders.

On the other hand, however, BMS can also be used to deliberately build up muscle, which is used in the field of sport but also in the health sector, for example when building up muscle as part of rehabilitation measures.

In addition, BMS can be used in the field of cosmetics, for example to combat the formation of wrinkles or cellulite.

Devices for carrying out BMS have already been described in the prior art, for example in DE-A-199 44 456, DE-U-201 16 277 or DE-U-202 19 435. In this case, BMS is carried out in a more or less linear (vertical) direction with the aid of randomly generated vibrations. This results in a travel which has a disadvantageous effect on the user. In addition, the devices are designed in such a manner that only a limited number of body parts, for example only the leg or arm area, can be subjected to BMS.

It was the object of the present invention to provide a device for improved biomechanical stimulation, which device can be used in a more versatile manner and is more effective than the devices disclosed in the prior art.

This object is achieved by means of a device as claimed in claim 1.

It has surprisingly been found that BMS can be carried out in an advantageous manner if the stimulation is generated by means of a uniform circular or elliptical movement. In contrast to the devices from the prior art, the device according to the invention exerts not only a vertical force but also a tensile force which acts in an essentially parallel manner. This results in considerably improved biomechanical stimulation of that part of the body which is situated on the device.

The European patent applications no. 03028004.4 and no. 04000668.6, which are likewise pending, have already described devices which are based on the above stimulation principle. In this case, frequencies of preferably 5-50 Hz are transmitted to the relevant part of the body by means of an absolutely forced movement of the device. However, these devices are relatively heavy and unwieldy on account of their size. In addition, selective biomechanical stimulation of certain parts of the body is possible only to a limited extent.

In contrast, the device of the present invention comprises a bottom unit, a base unit which is fitted to the bottom unit in such a manner that the position of the base unit relative to the bottom unit can be changed in an infinitely variable manner, and a cylindrical stimulation unit which contains a drive motor and is connected to the base unit in such a manner that, during operation, it carries out a circular or elliptical movement about an axis that differs from the cylinder axis and undergoes parallel displacement in the process.

The cylinder axis is the axis which runs through the center of the base and cover surfaces of the cylindrical bottom unit of the stimulation unit.

In comparison with known devices, the device has a compact construction. According to one preferred embodiment, the longest dimension of the bottom unit does not exceed 80 cm. The base unit can be moved toward the bottom unit (folded state) for the purpose of transportation. The base unit can preferably be moved manually using a foot pedal.

The device according to the invention preferably has holding or carrying handles on the bottom unit and/or base unit. The device is comparatively light and can be carried without any problems by 2 people, in particular when folded.

The bottom unit is manufactured from a material which is conventionally used for such components, for example from metal or a suitable plastic.

The bottom unit generally has at least one plate having sufficient dimensions for ensuring that the device according to the invention is erected on a base, such as the floor, in a stable manner. However, it is also possible to hang the device according to the invention from a wall or a ceiling. In this case, the bottom unit only comprises suitable conventional apparatuses for fastening the rest of the device to the wall or ceiling.

The bottom unit also preferably has at least one holding or carrying handle.

The base unit is fastened to the bottom unit such that it can be moved. Fastening is preferably effected using at least one separate component. In this case, it is possible to use any appropriate conventional connection option which can be used to adjust a solid component in an infinitely variable manner.

According to the invention, the base unit is preferably connected, on the one hand, to the bottom unit using screws, such that it can be moved. In this preferred embodiment, the ability to adjust the height in an infinitely variable manner and the ability to be fixed are achieved using at least one spring connection, preferably two spring connections, for example using conventional gas-filled compression springs which connect the bottom unit and the base unit to one another at another location. The ability to adjust the height can be achieved by moving the springs up and down. For example, the springs may be connected to a foot pedal and can thus be manually adjusted by operating the foot pedal.

The base unit contains the apparatus for controlling the motor contained in the stimulation unit. The bottom unit is connected to the cylindrical stimulation unit by means of the base unit.

The connection between the bottom unit and the base unit has already been explained above. At its other end, the base unit is connected to the cylindrical stimulation unit in such a manner that the latter can carry out the desired circular or elliptical movement during operation. This can be achieved in a conventional manner known to a person skilled in the art.

According to the invention, the base unit and the stimulation unit are preferably connected to one another by means of the motor arranged in the stimulation unit. In this embodiment, the stimulation unit has an opening through which the motor in the stimulation unit is connected to the base unit. In this embodiment, the base unit thus constitutes the base of the motor.

According to one particularly preferred embodiment, the base unit has two parts. The lower part of the base unit can be removed for installation or maintenance purposes. As a result, the motor in the stimulation unit becomes accessible from the outside by means of the opening described above. In this embodiment, the two parts of the base unit can be connected to one another in a conventional manner, for example by means of screws.

The base unit preferably also has at least one holding or carrying handle, in particular if only such a holding or carrying handle is arranged on the bottom unit. The base unit is manufactured from a material which is conventionally used for such components, preferably from metal.

The stimulation unit comprises a cylindrical basic body, in the interior of which the drive motor is situated. The cylindrical basic body is manufactured from a metal which is conventionally used for such components. Its outside is coated with a layer made from a soft material such as foam or rubber.

The base surface and/or the cover surface of the cylindrical basic body can preferably be removed. The base surface and/or the cover surface additionally preferably has/have ventilation slots.

The drive motor is preferably a conventional electric motor with an eccentric shaft.

Both the base surface and the cover surface are preferably connected to the eccentric shaft of the drive motor, by means of a respective ball bearing, in such a manner that, during operation, the cylindrical basic body carries out a circular or elliptical movement about an axis that differs from the cylinder axis and undergoes parallel displacement in the process. This movement has already been described in the pending European patent applications no. 03028004.4 and no. 04000668.6, reference being expressly made to the contents of said applications in this respect. The movement is fundamentally characterized in that the stimulation unit undergoes virtually no travel during operation, that is to say the travel is generally 1-2 mm at most.

During operation, the stimulation unit thus undergoes a uniform circular or elliptical movement. In contrast to the devices from the prior art, which carry out a random movement, the movement is forced on the whole and is absolutely uniform in the device according to the invention. It has been shown that biomechanical muscle stimulation can be carried out in a considerably more effective manner in this way than if BMS is carried out using random and therefore non-uniform movements. In contrast to the devices from the prior art, the device according to the invention exerts not only a vertical force but also a tensile force which acts in an essentially parallel manner. This results in considerably improved biomechanical stimulation of that part of the body which is situated on the platform.

A circular movement is preferred according to the invention. According to the present invention, a circular movement is understood as meaning a movement which differs from an ideal circular movement by no more than 5%.

According to the invention, the platform is preferably moved at a frequency of 5 to 50 Hz, preferably 5 to 35 Hz.

According to another preferred embodiment, the drive motor is also connected at least to the base surface or the cover surface by means of a plurality of rubber elements, preferably four rubber elements. This way of fastening the motor, which differs from the conventional procedure, makes it possible to reduce the dimensions of the device and the production costs.

According to one preferred embodiment, the stimulation unit has an opening through which the motor—after one part of the base unit has been removed—is accessible for installation or maintenance work.

The device according to the invention can be used in the fields of fitness and cosmetics and in the health sector. In the field of fitness, building up muscle and increasing the endurance of the user are most important. In the field of cosmetics, the device can be used to combat cellulite or the formation of wrinkles, for example. In the health sector, the device according to the invention can be used, for example, for the following indications: connective tissue weakness, degenerative rheumatic illnesses, migraine, muscle tenseness or weakness, pain in the muscle and locomotor system, building up musculature in the case of muscular atrophy, degenerative processes in intervertebral disks (arthroses), fractures, joint disorders (for example tennis or golf elbow), joint instability, myelosis, shoulder, back, hip, knee and ankle joint complaints, circulatory disorders, congestion syndrome (leg ulcers), edema resorption, neuropathies, boosting metabolism, urinary incontinence, multiple sclerosis, muscular dystrophy, Parkinson's disease, stroke, arthrogenic (venous) congestion syndrome (leg ulcers), circulatory disorders, Ehlers-Danlos syndrome, dermatosclerosis, periodontosis, mandibular complaints, improving circulation in the optic nerve, strengthening the orbicular muscle of the eye, partial paralysis of the facial nerves, forehead and maxillary sinus symptoms, chronic rhinitis, tinnitus and osteoporosis.

A fundamental advantage of the device according to the invention is the ability to stimulate certain selected parts of the body, for example the thigh muscles or the back muscles, in a targeted manner.

The present invention will be explained in more detail below, in a non-restrictive manner, using one preferred embodiment and with reference to drawings, in which:

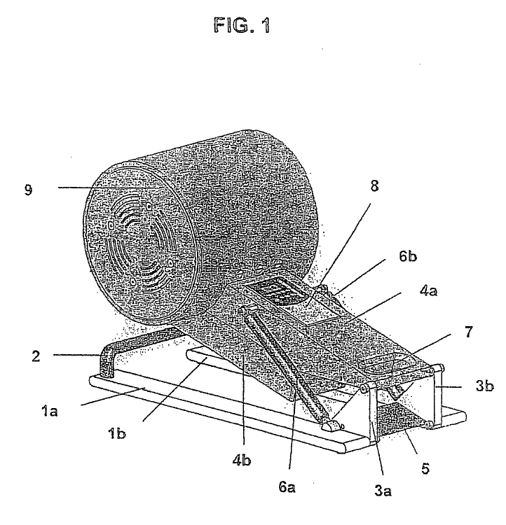

FIG. 1 shows one preferred embodiment of the device of the present invention,

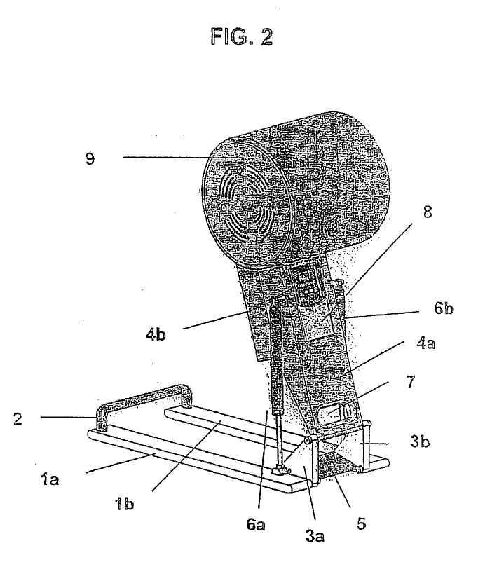

FIG. 2 shows the embodiment shown in FIG. 1 in the opened-out state,

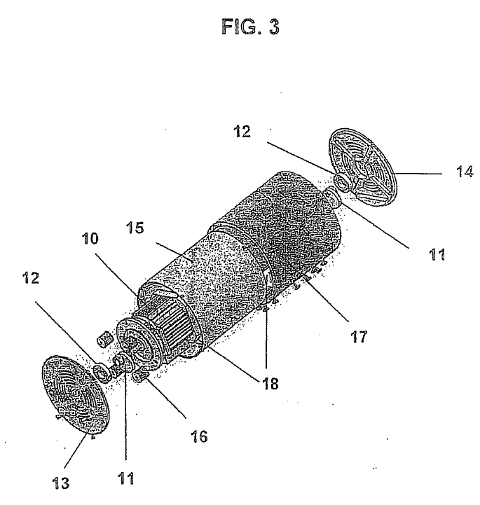

FIG. 3 shows the stimulation unit of the embodiment shown in FIG. 1.

According to one preferred embodiment shown in FIGS. 1 and 2, the device according to the invention comprises a bottom unit comprising two longitudinal plates 1a and 1b each having dimensions of approximately 80 cm×5 cm. At one end, the two longitudinal plates 1a and 1b are connected to one another by means of a holding handle 2. The holding handle 2 is securely screwed to the two longitudinal plates 1a and 1b.

At the other end, the longitudinal plates each have a connecting element 3a and 3b on the side facing the other longitudinal plate. In this embodiment, these connecting elements 3a and 3b are triangular and are screwed to the respective longitudinal plate 1a and 1b. The base part 4 is rotatably fixed to the respective free corner of the connecting elements 3a and 3b using screws.

A foot pedal 5 is arranged between the two connecting elements 3a and 3b such that it can be moved. The height of two gas-filled compression springs 6a and 6b can be adjusted by operating the foot pedal 5. A respective gas-filled compression spring is arranged on one of the two longitudinal plates and is also connected to the foot pedal 5. FIG. 2 shows the device shown in FIG. 1 in an opened-out state.

The base part 4 comprises two parts 4a and 4b. The upper part 4a has a holding handle 7. In addition, the upper part 4a has an opening into which the control unit 8, which is fitted to the lower part 4b, can be inserted. The two parts 4a and 4b are connected to one another by means of screws.

The lower part 4b is also connected to the drive motor contained in the stimulation unit 9. Removing the lower base part 4b makes the drive motor accessible for installation or maintenance work.

FIG. 3 shows, in detail, the stimulation unit 9 of the embodiment shown in FIG. 1. The drive motor 10 has an eccentric shaft 11 at both ends. Said shaft is connected to the base 13 and to the cover surface 14 of the cylindrical basic body 15 by means of ball bearings 12a and 12b. The base 13 and the cover surface have ventilation slots. The motor 10 is also connected, via four rubber elements 16, to the base 13 by means of screws. The cylindrical basic body 15 is completely surrounded, except for a recess 18, by a foam layer 17. The recess 18 is present both in the cylindrical basic body 15 and in the foam layer 17. The motor 10 is connected to the base part 4b and—after the base part 4b has been removed—is accessible from the outside for installation or maintenance work through this recess 18. The cylindrical basic body 15 and the layer 17 are screwed to one another.

1. A device for biomechanical stimulation, said device comprising a bottom unit, a base unit which is fitted to said bottom unit in such a manner that the position of said base unit relative to said bottom unit can be changed in a an infinitely variable manner, and a cylindrical stimulation unit which contains a drive motor and is connected to said base unit in such a manner that, during operation, it carries out a circular or elliptical movement about an axis that differs from the cylinder axis and undergoes parallel displacement in the process.

2. The device as claimed in claim 1, wherein said bottom unit has at least one holding or carrying handle.

3. The device as claimed in claim 1, wherein said bottom unit comprises two longitudinal plates which are connected to one another by means of a holding handle.

4. The device as claimed in claim 1, wherein said bottom unit is connected to said base unit by means of at least one separate component.

5. The device as claimed in claim 1, wherein said bottom unit is connected to said base unit both by means of at least one screw connection and by means of at least one spring connection.

6. The device as claimed in claim 1, wherein said base unit can be moved using a foot pedal.

7. The device as claimed in claim 1, wherein said bottom unit is connected to said base unit by means of two connecting elements using screws and by means of two springs, the height of said springs being able to be adjusted using a foot pedal.

8. The device as claimed in claim 1, wherein said base unit comprises an apparatus for controlling said drive motor.

9. The device as claimed in claim 1, wherein said drive motor is used to connect said base unit and said stimulation unit through an opening contained in said stimulation unit.

10. The device as claimed in claim 1, wherein said base unit comprises two components which can be separated from one another.

11. The device as claimed in claim 1, wherein said base unit has at least one holding or carrying handle.

12. The device as claimed in claim 1, wherein said stimulation unit comprises a cylindrical basic body, a drive motor which is contained in said basic body, and a layer which is a r-ranged on the outside of said basic body and is made from a soft material.

13. The device as claimed in claim 1, wherein said drive motor is an electric motor with an eccentric shaft.

14. The device as claimed in claim 12, wherein at least the base surface or the cover surface of said cylindrical basic body of said stimulation unit is connected to said drive motor by means of a plurality of rubber elements.

15. The device as claimed in claim 14, wherein said stimulation unit is connected to said drive motor by means of four rubber elements.
